(19) United States
(12) Patent Application Publication
(10) Pub. No.: US 2019/0060932 A1
(43) Pub. Date: Feb. 28, 2019

(54) FOAMER DISPENSER, AND CONTAINER WITH FOAMER DISPENSER

(71) Applicants: Hiroshi MIZUSHIMA, Tokyo (JP); Tsuyoshi SASAKI, Tokyo (JP)

(72) Inventors: Hiroshi MIZUSHIMA, Tokyo (JP); Tsuyoshi SASAKI, Tokyo (JP)

(73) Assignee: YOSHINO KOGYOSHO CO., LTD., Tokyo (JP)

(21) Appl. No.: 16/177,797

(22) Filed: Nov. 1, 2018

Related U.S. Application Data
(62) Division of application No. 14/904,798, filed on Jan. 13, 2016, now Pat. No. 10,144,026.

(30) Foreign Application Priority Data
Jul. 17, 2013 (JP) 2013-148954
Jul. 17, 2013 (JP) 2013-148956

(51) Int. Cl. B05B 11/00; B05B 7/00

(52) U.S. Cl. CPC B05B 11/3087; B05B 11/3097; B05B 11/3059; B05B 11/3001; B05B 11/3047; B05B 11/0075; B05B 11/0064; B05B 7/0037; B05B 11/0044

(57) ABSTRACT

A foamer dispenser including a mesh filter that is disposed in a mixture flow path of a jet ring to allow a mixture to pass is provided. A connecting flow path area between a liquid flow path and the mixture flow path and a connecting flow path area between an ambient air flow path and the mixture flow path have the relation 2.8≤S₁/S₂≤3.8, and/or, a smallest flow path area of the mixture flow path is located on an immediately upstream side of the mesh filter, and the smallest flow path area and a flow path area of the mesh filter have the relation 4≤S₄/S₃≤10.3.

### CROSS REFERENCE TO RELATED APPLICATIONS

This application is a divisional of U.S. patent application Ser. No. 14/904,798, filed Jan. 13, 2016, pending, which is a 371 of International Application No. PCT/JP2014/003814, filed Jul. 17, 2014, the contents of which are incorporated herein by reference.

### TECHNICAL FIELD

The present disclosure relates to a foamer dispenser, an container with the foamer dispenser.

### BACKGROUND

Some known containers are equipped with a foamer dispenser that causes a liquid pumped out of a container body to be ejected in the form of foam through a foaming net (mesh filter) by repeated pushing and releasing of the head. (Refer to Patent Literature 1, for example.)

### CITATION LIST

### Patent Literature

PTL1: JPH08230961A

### SUMMARY

### Technical Problem

Even such a conventional foamer dispenser can suffer from variation in foam quality depending on ingredients or the like of the liquid to be foamed. For example, as illustrated in FIG. 5A, even in a single piece of foam F, a small air bubble B₁ and a large air bubble B₂ are sometimes present. For the foam with such a quality, there is room for improvement in terms of the appearance and texture.

The present disclosure is to provide a foamer dispenser and a container with the foamer dispenser both of which are capable of ejecting a content medium with a satisfactory foam quality.

### Solution to Problem

One of aspects of the present disclosure resides in a foamer dispenser, including: a pump cover that is fitted to a container body; a pump cylinder that includes a large-diameter portion fixed to the pump cover and a small-diameter portion; a small-diameter piston that is received in the small-diameter portion of the pump cylinder and that is configured to suck and pump a liquid in the container body; a large-diameter piston that is received in the large-diameter portion of the pump cylinder and that is configured to suck and pump ambient air; a head that causes pumping movement of the small-diameter piston and the large-diameter piston and that ejects a mixture of the liquid and the ambient air by a user pushing and releasing the head repeatedly; a liquid flow path of the liquid pumped from the small-diameter piston; an ambient air flow path of the ambient air pumped from the large-diameter piston; a mixture flow path of the mixture of the liquid pumped from the liquid flow path and the ambient air pumped from the ambient air flow path; and a mesh filter that is disposed in the mixture flow path to allow the mixture to pass, wherein

a connecting flow path area S₁ between the liquid flow path and the mixture flow path and a connecting flow path area S₂ between the ambient air flow path and the mixture flow path have the following relation:

2.85≤S₁/S₂≤3.8

(S₁:S₂=(2.8 to 3.8): 1)

In a preferred embodiment, the connecting flow path area S₁ and the connecting flow path area S₂ have the following relation:

S₁/S₂=3.8

(S₁:S₂=3.8:1)

In another preferred embodiment, a smallest flow path area S₃ of the mixture flow path is located on an immediately upstream side of the mesh filter, and the smallest flow path area S₃ and a flow path area S₄ of the mesh filter have the following relation:

4≤S₄/S₃≤10.3

(1:4≤S₃:S₄≤1:10.3)

(S₃:S₄=1:(4 to 10.3))

Another aspect of the present disclosure resides in a foamer dispenser, including: a pump cover that is fitted to a container body; a pump cylinder that includes a large-diameter portion fixed to the pump cover and a small-diameter portion; a small-diameter piston that is received in the small-diameter portion of the pump cylinder and that is configured to suck and pump a liquid in the container body; a large-diameter piston that is received in the large-diameter portion of the pump cylinder and that is configured to suck and pump ambient air; a head that causes pumping movement of the small-diameter piston and the large-diameter piston and that ejects a mixture of the liquid and the ambient air by a user pushing and releasing the head repeatedly; a liquid flow path of the liquid pumped from the small-diameter piston; an ambient air flow path of the ambient air pumped from the large-diameter piston; a mixture flow path of the mixture of the liquid pumped from the liquid flow path and the ambient air pumped from the ambient air flow path; and a mesh filter that is disposed in the mixture flow path to allow the mixture to pass, wherein

a smallest flow path area S₃ of the mixture flow path is located on an immediately upstream side of the mesh filter, and the smallest flow path area S₃ and a flow path area S₄ of the mesh filter have the following relation:

4≤S₄/S₃≤10.3

(1:4≤S₃:S₄≤1:10.3)

(S₃:S₄1:(4 to 10.3))

In a preferred embodiment, the smallest flow path area S₃ and the flow path area S₄ of the mesh filter have the following relation:

4≤S₄/S₃≤10.1

(1:4≤S₃:S₄≤1:10.1)

(S₃:S₄=1:(4 to 10.1))

In another preferred embodiment, the smallest flow path area S₃ and the flow path area S₄ of the mesh filter have the following relation:

4≤S₄/S₃≤6.2

(1:4≤S₃:S₄≤1:6.2)

(S₃:S₄=1:(4 to 6.2))

In a more preferred embodiment, the smallest flow path area S₃ and the flow path area S₁ of the mesh filter have the following relation:

S₄/S₃=4

(S₃:S₄=1:4)

In yet another preferred embodiment, the mesh filter is arranged in 2 locations in the mixture flow path, and an interval L₁ between the smallest flow path area S₃ and the flow path area S₄ of the mesh filter and an interval L₂ between the mesh filters have the following relation:

L₂/L₁=3.9

(L₁:L₂=1:3.9)

In yet another preferred embodiment, the foamer dispenser further includes: a piston guide, inside of which the liquid flow path of the liquid pumped from the small-diameter piston is formed, and which extends throughout the large-diameter piston in a manner such that relative movement is permitted; and a jet ring, which includes a lower-end side concave portion in which an upper end side of the piston guide is received, an upper-end side concave portion in which the mesh filter is received, and a through path provided in a separation wall separating the lower-end side concave portion from the upper-end side concave portion, wherein an upper end side of the jet ring is connected to the head.

Yet another aspect of the present disclosure resides in a container with a foamer dispenser, including: the foamer dispenser according to any one of the above embodiments; and a container body to which the foamer dispenser is fitted.

### Advantageous Effect

The present disclosure makes the foam quality of the ejected foam fine and uniform, thereby improving the appearance and texture when a user places the foam on the hand.

### BRIEF DESCRIPTION OF THE DRAWINGS

In the accompanying drawings:

FIG. 1 is a sectional view of a part of a container with a foamer dispenser according to one of embodiments of the present disclosure;

FIG. 2 is an enlarged view of an upper end portion of a piston guide of FIG. 1; FIG. 3 is an enlarged view of FIG. 1;

FIG. 4 is a part view of a section of a jet ring in which a mesh ring is mounted; and

FIG. 5A schematically illustrates the foam quality obtained when a content medium in a container body is ejected by using a conventional foamer dispenser, and

FIG. 5B schematically illustrates the foam quality obtained when a content medium in a container body is ejected by using the foamer dispenser of FIG. 1.

### DETAILED DESCRIPTION

The following describes a container with a foamer dispenser according to the present disclosure in detail with reference to the drawings.

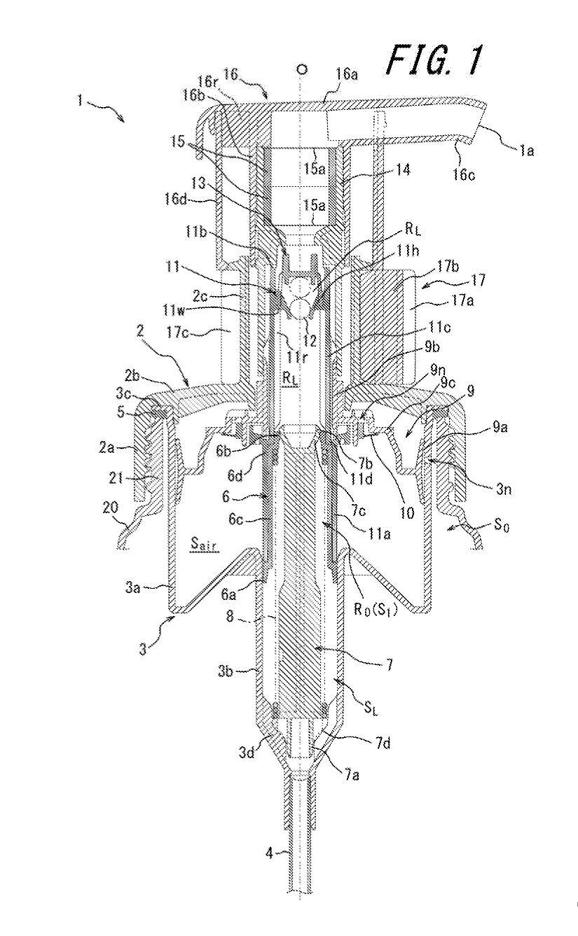

FIGS. 1 to 4 illustrate a container with a foamer dispenser and a part thereof according to the present disclosure. In FIG. 1, reference numeral 20 denotes a synthetic resin container body including a mouth 21. A liquid content medium is filled into an inner space S₀ of the container body 20 through the mouth 21. In the present embodiment, the container body 20 is a container having a larger capacity than a capacity of a conventional container.

Reference numeral 1 denotes a foamer dispenser according to one of embodiments of the present disclosure. The foamer dispenser 1 is capable of ejecting a 3 cc of the content medium in the form of foam.

Reference numeral 2 denotes a synthetic resin pump cover. The pump cover 2 includes a fitting portion 2a to be fitted to the mouth 21 of the container body 20 and a neck 2c connected integrally with the fitting portion 2a via a shoulder 2b. The neck 2c is provided, inside thereof, with a through path. The pump cover 2 may, for example, be provided with a screw portion on an inner circumferential surface of the fitting portion 2a as illustrated in the figure and be detachably fitted to the container body 20 by screwing the screw portion to a screw portion provided on an outer circumferential surface of the mouth 21 of the container body 20.

Reference numeral 3 denotes a synthetic resin pump cylinder. The pump cylinder 3 includes a large-diameter portion 3a fixed to the pump cover 2 and a small-diameter portion 3b having a smaller diameter than the large-diameter portion 3a. The small-diameter portion 3b is provided in a lower end portion thereof with a suction port, and a tube 4 is connected to the suction port. When the pump cover 2 is fitted to the mouth 21 of the container body 20, the pump cylinder 3 is positioned in the inner space S₀ through the mouth 21 of the container body 20 as illustrated in the figure. In the illustrated example, an upper end of the large-diameter portion 3a of the pump cylinder 3 is formed as an outward annular flange 3c. Between the annular flange 3c and an upper end of the mouth 21 of the container body 20, an O-ring 5 is disposed. The O-ring seals between the container body 20 and the pump cylinder 3.

Reference numeral 6 denotes a synthetic resin small-diameter piston. The small-diameter piston 6 is received in the small-diameter portion 3b of the pump cylinder 3 and configured to suck and pump the content medium in the container body 20. In the present embodiment, the small-diameter piston 6 includes an annular seal portion 6a, which is slidable on an inner circumferential surface of the small-diameter portion 3b of the pump cylinder 3, and a tubular portion 6c, which extends from the annular seal portion 6a toward the large-diameter portion 3a of the pump cylinder 3. The tubular portion 6c is provided on an inner side thereof with a through path R₀ which is open in an upper end portion 6b of the small-diameter piston 6. In the present embodiment, the upper end portion 6b of the small-diameter piston 6 is connected to the tubular body 6c via an annular step 6d. Accordingly, a step is also formed in the through path R₀ due to the annular step 6d, and an inner diameter of an upper end opening formed in the upper end portion 6b is smaller than a lower end opening formed on an inner side of the annular seal portion 6a.

Reference numeral 7 denotes a synthetic resin plunger. The plunger 7 extends upward inside the pump cylinder 3 from the small-diameter portion 3b to the large-diameter portion 3a of the pump cylinder 3 and also extends throughout the small-diameter piston 6.

In the present embodiment, a plurality of fins 7d is disposed at an interval about an axis O in a lower end portion 7a of the plunger 7. Furthermore, a plurality of fins 3d is disposed at an interval about the axis O in the small-diameter portion 3b of the pump cylinder 3. The plunger 7 is arranged in the small-diameter portion 3b of the pump cylinder 3 in a manner such that the fins 7d of the plunger 7 are alternated with the fins 3d of the pump cylinder 3.

On the other hand, an upper end portion 7b of the plunger 7 includes a conical portion 7c having a diameter increased upward. The conical portion 7c of the plunger 7 is formed larger than the inner diameter of the opening formed in the upper end portion 6b of the small-diameter piston 6. As described earlier, the upper end portion 6b of the small-diameter piston 6 is reduced in diameter via the annular step 6d. The conical portion 7c of the plunger 7 may be brought into contact with the upper end portion 6b of the small-diameter piston 6 by forcedly extracting the opening formed in the upper end portion 6b. That is to say, by the conical portion 7c of the plunger 7 contacting the upper end portion 6b of the small-diameter piston 6, the upper end opening formed in the upper end portion 6b may be sealed in an operable manner. As a result, a pump chamber S_{L}, is formed in the small-diameter portion 3b of the pump cylinder 3. The content medium, after pressurized in the small-diameter piston 6, is pumped out from the pump chamber S_{L} by releasing of the plunger 7.

Reference numeral 8 denotes an elastic member that may be deformed and restored. The elastic member 8 is disposed between the plunger 7 and the small-diameter piston 6 in a compressed state. Accordingly, by pressing the upper end opening of the small-diameter piston 6 against the outer circumferential surface of the conical portion 7c of the plunger 7, the elastic member 8 firmly seals the through path R₀ of the small-diameter piston 6 in an openable manner. That is to say, the plunger 7 serves, only when the small-diameter piston 6 is pushed down against elastic force of the elastic member 8, as a suction valve (check valve) configured to open the through path R₀ of the small-diameter piston 6. In the present embodiment, the elastic member 8 is formed by a metallic or a synthetic resin spring.

Reference numeral 9 denotes a synthetic resin large-diameter piston. The large-diameter piston 9 has a diameter that is larger than the diameter of the small-diameter piston 6. The large-diameter piston 9 is received in the large-diameter portion 3a of the pump cylinder 3 and configured to suck and pump ambient air. In the present embodiment, the large-diameter piston 9 includes an annular seal portion 9a, which is slidable on an inner circumferential surface of the large-diameter portion 3a of the pump cylinder 3, and a tubular portion 9b, which extends upward from the annular seal portion 9a via an annular wall 9c. The tubular portion 9b is provided, inside thereof, with a through path.

The annular wall 9c of the large-diameter piston 9 is provided with a plurality of ambient air introduction holes 9n arranged at an interval about the axis O. The ambient air introduction holes 9n allow ambient air, after introduced through an ambient air introduction hole 3n formed in the large-diameter portion 3a of the pump cylinder 3, to be introduced to an air pump chamber Sₐᵢᵣ formed between the large-diameter piston 9 and the large-diameter portion 3a of the pump cylinder 3.

Reference numeral 10 denotes a check valve configured to open and close the ambient air introduction holes 9n provided in the large-diameter piston 9. When the large-diameter piston 9 is pushed in and the air pump chamber Sₐᵢᵣ is compressed, the check valve 10 closes the ambient air introduction holes 9n of the large-diameter piston 9 to prevent outflow of ambient air, and when the pushing of the large-diameter piston 9 is released and the air pump chamber Sₐᵢᵣ is expanded, the check valve 10 opens the ambient air introduction holes 9n of the large-diameter piston 9 by the negative pressure in the air pump chamber Sₐᵢᵣ to allow ambient air to be introduced through the ambient air introduction hole 3n of the pump cylinder 3. Examples of the check valve 10 include an elastic valve made of a synthetic resin.

Reference numeral 11 denotes a synthetic resin piston guide. The piston guide 11 is provided inside thereof with a liquid flow path R_{L} of the content medium pumped from the small-diameter piston 6 and extends throughout the large-diameter piston 9 in a manner such that relative movement is permitted. In the present embodiment, the piston guide 11 includes a fixed tube 11a, which is fixed to an outer circumferential surface of the tubular portion 6c of the small-diameter piston 6 and a tubular portion 11c, which extends upward from the fixed tube 11a toward the neck 2c of the pump cover 2. In the present embodiment, the tubular portion 11c of the piston guide 11 is connected to the fixed tube 11a via an annular step 11d. The above structure allows positioning of the small-diameter piston 6 by bringing the annular step 6d into abutment against the annular step lid of the piston guide 11.

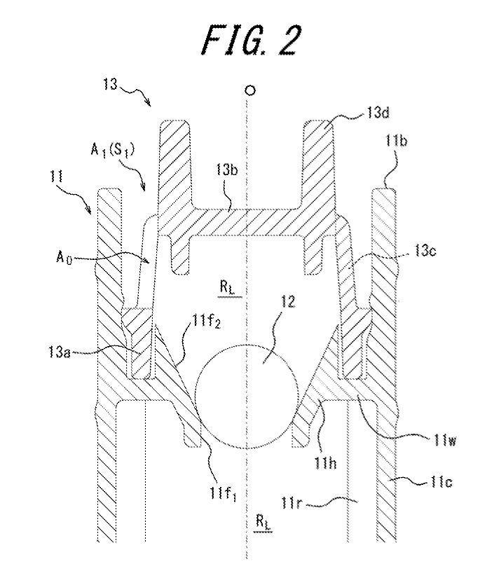

The piston guide 11 is also provided inside thereof with a partition wall 11w located below an upper end 11b of the piston guide 11. In the partition wall 11w of the piston guide, a tubular portion 11h is provided. As illustrated in FIG. 2, the through path formed on an inner side of the tubular portion 11h is defined by a constant-diameter inner circumferential surface 11f₁ extending from the lower end with a constant diameter and an increased-diameter inner circumferential surface 11f₂ connected to the constant-diameter inner circumferential surface 11f₁ with a diameter increasing toward the upper end.

Furthermore, in the present embodiment, as illustrated in FIG. 2, the tubular portion 11c is provided, on an inner circumferential surface thereof, with a plurality of protruding ridges 11r extending toward the lower end from the partition wall 11w. In the present embodiment, the protruding ridge 11r is arranged in 6 locations at an interval about the axis O. However, the protruding ridge 11r may be arranged in at least one location.

Reference numeral 12 denotes a metallic or a synthetic resin ball member. The ball member 12 rests on the increased-diameter inner circumferential surface 11f₂ of the tubular portion 11h provided in the piston guide 11 to seal the inner side of the tubular portion 11h in an openable manner.

Reference numeral 13 denotes a synthetic resin slip-off preventing member configured to prevent the ball member 12 from slipping out. The slip-off preventing member 13 is fixed to the inner circumferential surface of the piston guide 11 that is located near the upper end 11b to form space in which the ball member 12 is received. The slip-off preventing member 13, together with the piston guide 11, forms an opening port A₁ on an inner side of the upper end 11b of the piston guide 11. The opening port A₁ serves to open the liquid flow path R_{L} provided in the piston guide 11.

In the present embodiment, the slip-off preventing member 13 includes a circumferential wall 13a, which is fixed between the inner circumferential surface of the piston guide 11 that is located near the upper end 11b and the tubular portion 11h, a ceiling wall 13b located above the ball member 12, and a plurality of connecting pieces 13c connected to the ceiling wall 13b and the circumferential wall 13a. The connecting pieces 13c are arranged at an interval about the axis O, so that a plurality of apertures A₀ are formed between adjacent connecting pieces 13c. For example, 3 apertures A₀ may be formed. In the present embodiment, a tubular portion 13d extends upward from and is integrated with an outer edge of the ceiling wall 13b. The above structure forms the annular opening port A₁ extending around the axis O on the inner side of the upper end 11b of the piston guide 11 and between the upper end 11b and the tubular 13d. That is to say, in the present embodiment, the opening port A₁ of the liquid flow path R_{L} forms an annular flow path area S₁ defined by the upper end 11b of the piston guide 11 and the tubular portion 13d of the slip-off preventing member 13.

In this way, in the liquid flow path R_{L} provided inside the piston guide 11 in the present embodiment, the annular opening port A₁ formed in the upper end 11b of the piston guide 11 is opened and closed by the ball member 12. That is to say, the ball member 12 serves as a discharge valve (check valve) that, only when the plunger 7 is released and the content medium is pumped to the liquid flow path R_{L} of the piston guide 11, opens the annular opening port A₁ formed in the upper end 11b of the piston guide 11. Especially in the present embodiment, the liquid flow path R_{L} formed between the plunger 7 and the ball member 12 also serves as an accumulator that pressurizes the content medium, after pumped from the small-diameter piston 6, to a predetermined pressure and pump the pressurized content medium.

As illustrated in FIG. 3, the tubular portion 11c of the piston guide 11 extends throughout the inner side of the tubular portion 9b of the large-diameter piston 9. Between the tubular portion 11c of the piston guide 11 and the tubular portion 9b of the large-diameter piston 9, a gap is formed to allow relative movement in the direction of the axis O.

Besides, the tubular portion 11c of the piston guide 11 is provided with a plurality of annular protrusions 11c extending around the axis O. Each annular protrusion 11e is provided, on an upper side thereof, with an annular groove 11g extending around the axis O. A lower end portion 9d of the tubular portion 9b of the large-diameter piston 9 may be brought into contact with the annular groove 11g. With the above structure, when the lower end portion 9d of the tubular portion 9b of the large-diameter piston 9 comes off the annular groove 11g of the piston guide 11 and the contact is released, the air pump chamber Sₐᵢᵣ, which is formed between the large-diameter piston 9 and the large-diameter portion 3a of the pump cylinder 3, is brought into communication with the gap formed between the tubular portion 11c of the piston guide 11 and the tubular portion 9b of the large-diameter piston 9. That is to say, the tubular portion 9b of the large-diameter piston 9 and the annular groove 11g of the piston guide 11 serve as an opening/closing valve, and the gap serves as the first ambient air path Rₐᵢᵣ for the ambient air which has been pumped from the large-diameter piston 9.

In the present embodiment, a plurality of protruding ridges 11k are provided at an interval about the axis O on an outer circumferential surface of the tubular portion 11c of the piston guide 11. In the present embodiment, the protruding ridge 11k is arranged in 12 locations at an interval about the axis O. The protruding ridges 11k guide ambient air without contacting the tubular portion 9b of the large-diameter piston 9. Additionally, the protruding ridge 11r may be arranged in at least one location.

In the present embodiment, an annular cutout extending around the axis O is further formed in an upper end of each annular protruding portion 11e. In the cut-out, a plurality of guide walls 11j are provided at an interval about the axis O, and a plurality of receiving portions C₃, configured to prevent inflow of foreign substances, is also provided between adjacent guide walls 11j. The guide walls 11j are arranged to be aligned with the protruding ridge 11k. That is to say, in the present embodiment, the guide wall 11j is also arranged in 12 locations at an interval about the axis O. However, the guide wall 11j may also be arranged in at least one location.

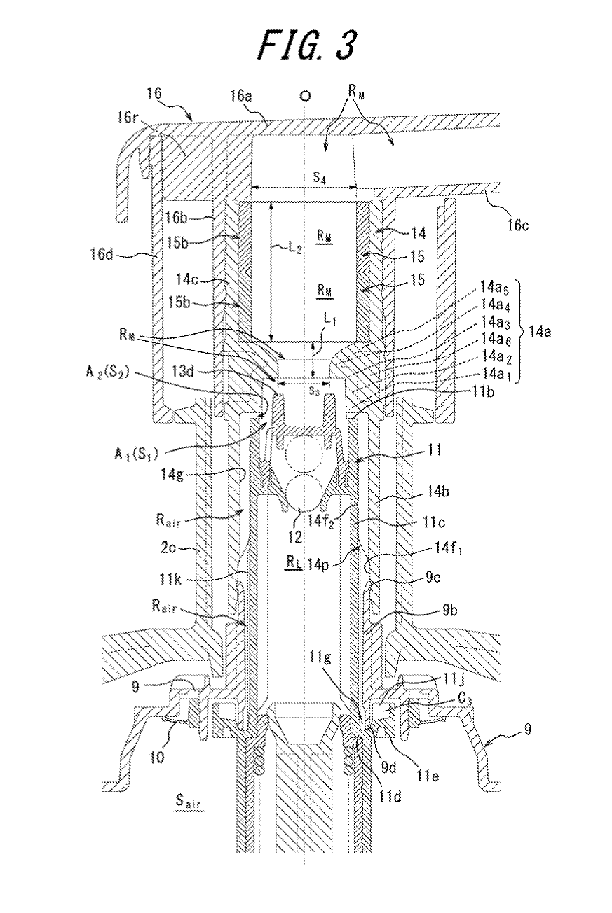

Reference numeral 14 denotes a synthetic resin jet ring. As illustrated in FIG. 4, the jet ring 14 includes a lower-end side concave portion C₁, in which the upper end 11b side of the piston guide 11 is received, an upper-end side concave portion C₂, in which two mesh rings 15 which are described later are received, and a separation wall 14a, which separates the lower-end side concave portion C₁ from the upper-end side concave portion C₂ and is provided with a through path. In the present embodiment, the separation wall 14a is formed as a circumferential wall that connects a lower-end side circumferential wall 14b, which surrounds the upper end 11b side of the piston guide 11, and an upper-end side circumferential wall 14c, which surrounds the two mesh rings 15.

In more detail, the separation wall 14a is formed by the first reduced circumferential wall portion 14a₁, which is connected to the lower-end side circumferential wall 14b and has an inner diameter smaller than the smaller inner diameter of the lower-end side circumferential wall 14b, a same-diameter circumferential wall portion 14a₂, which has the same inner diameter as the first reduced circumferential wall portion 14a₁, the second reduced circumferential wall portion 14a₃, which has an inner diameter smaller than that of the same-diameter circumferential wall portion 14a₂, a large-diameter circumferential wall portion 14a₄, which has a diameter increased from the second reduced circumferential wall portion 14a₃ to the upper end, and the third reduced circumferential wail portion 14a₅, which, together with the large-diameter circumferential wall portion 14a₄, is connected to the upper-end side circumferential wall 14c and which has an inner diameter smaller than that of the upper-end side circumferential wall 14c.

Especially in the present embodiment, a plurality of reinforcing plates 14a₆ is provided at an interval about the axis O between the first reduced circumferential wall portion 14a₁ and the third reduced circumferential wall portion 14a₅. The reinforcing plate 14a₆ may be arranged in 4 locations at an equal interval about the axis O. The result is that the separation wall 14a is formed as a waist, and the amount of resin used in the jet ring 14 is reduced. Moreover, the mesh ring 15 may be enlarged, and the amount of foam to be dispensed is increased. However, reinforcing plate 14a₆ may be arranged in at least one location.

Furthermore, an annular bulging portion 14p extending around the axis O is provided on an inner circumferential surface 14f₁ of the lower-end side circumferential wall 14b of the jet ring 14. The bulging portion 14p forms, on an inner side of the lower-end side circumferential wall 14b, an inner circumferential surface 14f₂ having an inner diameter smaller than that of the inner circumferential surface 14f₁. In the present embodiment, the inner diameter of the bulging portion 14p is defined as the smallest inner diameter of the lower-end side circumferential wail 14b. Besides, in the lower-end side concave portion C₁ of the jet ring 14, a plurality of L-shaped grooves 14g is formed to extend from the bulging portion 14p to the first reduced circumferential wall portion 14a₁ of the separation wall 14a. In the present embodiment, the L-shaped groove 14g is arranged in 12 locations at an interval about the axis O. However, the L-shaped groove 14g may be arranged in at least one location.

Reference numeral 15 denotes the mesh ring that is received in the upper-end side concave portion of the jet ring 14. The mesh ring 15 includes a mesh filter 15a. The mesh filter 15a is a member formed with fine apertures through which the content medium may pass and is, for example, a resin net. The mesh filter 15a is fixed to an end of a synthetic resin ring member 15b. The ring member 15b, together with the mesh filter 15a, is fitted and held inside the upper-end side concave portion C₂ of the jet ring 14.

As illustrated in FIG. 3, the jet ring 14 receives the upper end 11b side of the piston guide 11, with the upper end 11b of the piston guide 11 abutting against the first reduced circumferential wail portion 14a₁ and with the outer circumferential surface of the tubular portion 11c of the piston guide 11 fitted to an inner circumferential surface f₂ of the bulging portion 14p provided in the :tower-end side circumferential wall 14b. This allows the opening port A₁ of the piston guide 11 to communicate with the upper-end side concave portion C₂ of the jet ring 14 through the through path provided in the separation wall 14a of the jet ring 14.

Furthermore, since in the present embodiment the L-shaped grooves 14g are formed to extend from the bulging portion 14p of the jet ring 14 to the first reduced circumferential wall portion 14a₁ of the separation wall 14a, the second ambient air flow paths Rₐᵢᵣ are formed between the piston guide 11 and the jet ring 14. The second ambient air flow paths allow the ambient air that has been pumped from the large-diameter piston 9 to communicate with the through path provided in the separation wall 14a of the jet ring 14. In the present embodiment, 12 second ambient air flow paths Rₐᵢᵣ, defined by the L-shaped grooves 14g of the jet ring 14 and the piston guide 11, are formed. That is to say, in the present embodiment, an opening port A₂ of the second ambient air flow paths Rₐᵢᵣ has a flow path area S₂ defined by the L-shaped grooves 14g formed in the first reduced circumferential wail portion 14a₁ of the separation wall 14a of the jet ring 14 and the upper end 11b of the piston guide 11. Additionally, the second ambient air flow path Rₐᵢᵣ may be arranged in at least one location.

In the present embodiment, the inner circumferential surface 14f₁ of the lower-end side circumferential wall 14b of the jet ring 14 is sealed and slidably held by an upper end portion 9e of the tubular portion 9b of the large-diameter piston 9. This allows the second ambient air flow paths Rₐᵢᵣ to communicate with the first ambient air flow paths Rₐᵢᵣ in an air-tight manner.

The through path provided in the separation wall 14a forms the first mixture flow path R_{M} for a mixture of the content medium pumped from the opening port A₁ of the liquid flow path R_{L} and the ambient air pumped from the opening port A₂ of the second ambient air flow paths Rₐᵢᵣ. In the present embodiment, in a portion of the first mixture flow path R_{M} that is located on the inner side of the of the same-diameter circumferential wall 14a₂ of the jet ring 14, the tubular portion 13d of the slip-off preventing member 13 may be received. This enlarged path, in which the tubular portion 13d of the slip-off preventing member 13 is received, extends from the smallest inner diameter path formed on the inner side of the second reduced circumferential wall portion 14a₃ to the large-diameter circumferential wall portion 14a₄ and to the curved path formed on the inner side of the third reduced circumferential wall portion 14a₅ and then, communicates with the second mixture flow path R_{M} formed on the inner side of the ring member 15b of the mesh ring 15.

Next, reference numeral 16 in FIG. 3 denotes a synthetic resin head. By a user pushing and releasing the head 16 repeatedly, the head 16 causes pumping movement of the small-diameter piston 6 and the large-diameter piston 9 and ejects the mixture of the content medium and ambient air. In the present embodiment, the head 16 includes a ceiling wall 16a, on which the user performs a pushing operation, and a fixing tube 16b suspended from the ceiling wall 16a. Inside the fixing tube 16b, the upper-end side circumferential wall 14c of the jet ring 14 is fitted and held. The head 16 further includes a nozzle 16c communicating with the inside of the fixing tube 16b. As illustrated in FIG. 1, the nozzle 16c is provided in a front end thereof with an ejection orifice 1a from which the content medium, after passing through the mesh rings 15, is ejected in the form of foam.

Furthermore, the ceiling wall 16a of the head 16 is provided in a lower end thereof with a plurality of fixing ribs 16r extending radially around the fixing tube 16b. In the lower end of the ceiling wall 16a of the head 16, an outer tube 16d as a separate member is also disposed. In the present embodiment, the outer tube 16d may receive the fixing ribs 16r on the inner side of the outer tube 16d and may be fixed by the fixing ribs 16r.

In FIG. 1, reference numeral 17 denotes a stopper configured to prevent the head 16 form pushed down. The stopper 17 is an existing stopper that is arranged detachably between the shoulder 2c of the pump cover 2 and the outer tube 16d of the head 16. That is to say, the stopper 17 includes two curved arms 17c extending, in a C-shape in the cross section, from a base 17b having a grip 17a, thereby detachably fitted to the neck 2c of the pump cover 2. Thus, the stopper 17 contacts the upper end of the shoulder 2c and the lower end of the outer tube 16d and prevents the head 16 from pushed down.

The large container with a foamer dispenser according to the present disclosure allows a large volume of content medium, after pumped from the container body 20, to pass through the mesh filters 15a and ejects the content medium in the form of foam by repeated pushing and releasing of the head 16.

In the present embodiment, as illustrated in FIG. 3, a connecting flow path area S₁ between the liquid flow path R_{L} and the mixture flow path R_{M} and a connecting flow path area S₂ between the ambient air flow path Rₐᵢᵣ and the mixture flow path R_{M} are defined, and the connecting flow path area S₁ for the liquid and the connecting flow path area S₂ for ambient air satisfy the following condition.

2.8≤S₁/S₂≤3.8 (1)

(2.8:1≤S₁:S₂≤3.8:1)

More preferably, the connecting flow path area S₁ for the liquid and the connecting flow path area S₂ for ambient air are set to satisfy the following condition.

S₁/S₂=3.8 (2)

(S₁:S₂=3.8:1)

Furthermore, in the present embodiment, in a through path formed inside the jet ring 14, the same-diameter circumferential wall portion 14a₂ has the smallest inner diameter. That is to say, the smallest flow path area S₃ of the mixture flow path R_{M} is located on an immediately upstream side of one of the mesh filters 15a. In this case, the smallest flow path area S₃ of the mixture flow path R_{M} and a flow path area S₄ of the mesh filter 15a are preferably set to satisfy the following condition.

4≤S₄/S₃≤10.3 (3)

(1:4≤S₃:S₄≤1:10.3)

Preferably, the smallest flow path area S₃ of the mixture flow path R_{M} and the flow path area S₄ of the mesh filter 15a are set to satisfy the following condition.

4≤S₄/S₃≤6.2 (4)

(1:4≤S₃:S₄≤1:10.1)

More preferably, the smallest flow path area S₃ of the mixture flow path R_{M} and the flow path area S₄ of the mesh filter 15a are set to satisfy the following condition.

4≤S₄/S₃≤6.2 (5)

(1:4≤S₃:S₄≤1:6.2)

Even more preferably, the smallest flow path area S₃ of the mixture flow path R_{M} and the flow path area S₄ of the mesh filter 15a are set to satisfy the following condition.

S₄/S₃=4 (6)

(S₃:S₄=1:4)

Moreover, in the present embodiment, the mesh filter 15a is arranged in two locations in the mixture flow path R_{M}. In this case, an interval L₁ between the smallest flow path area S₃ of the mixture flow path R_{M} and the flow path area S₄ of the mesh filter 15a and an interval L₂ between the mesh filters 15a are preferably set to satisfy the following condition.

L₂/L₁=3.9 (7)

(L₁:L₂=1:3.9)

Moreover, the foamer dispenser of the present embodiment includes the piston guide 11, inside of which the liquid flow path R_{L} of the content medium pumped from the small-diameter piston 6 is formed, and which extends throughout the large-diameter piston 9 in a manner such that relative movement is permitted, and the jet ring 14, which includes the lower-end side concave portion C₁ in which the upper end 11b side of the piston guide 11 is received, the upper-end side concave portion C₂ in which the mesh filters 15a are received, and the through path provided in the separation wall 14a separating the lower-end side concave portion C₁ from the upper-end side concave portion C₂.

Furthermore, the annular bulging portion 14p is provided on the inner circumferential surface of the lower-end side concave portion C₁ of the jet ring 14, the upper end 11b of the piston guide 11 is abutted against the separation wall 14a of the jet ring 14, the piston guide 11 is fitted to the inner side of the bulging portion 14p, and the inner diameter surface of the lower-end side concave portion C₁ of the jet ring 14 is sealed slidably by the large-diameter piston 9.

Moreover, the plurality of L-shaped grooves 14g is formed to extend from the bulging portion 14p to the separation wall 14a of the jet ring 14 to form the plurality of ambient air flow paths Rₐᵢᵣ between the piston guide 11 and the jet ring 14. The ambient air flow paths allow the ambient air that has been pumped from the large-diameter piston 9 to communicate with the lower-end side concave portion C₁ of the jet ring 14. The ambient air flow paths Rₐᵢᵣ, together with the liquid flow path R_{L} of the piston guide 11, are connected to the through path of the separation wall 14a.

Moreover, the upper end 11b side of the jet ring 14 is connected to the head 16.

Using an assembly of the piston guide 11 and the jet ring 14 according to the present embodiment facilitates settings of the connecting flow path area S₁ for the liquid and the connecting flow path area S₂ for ambient air. For example, as illustrated in FIG. 2, the connecting flow path area S₁ for the liquid is defined between the upper end 11b of the piston guide 11 and the tubular portion 13d of the slip-off preventing member 13. Accordingly, the connecting flow path area S₁ for the liquid may be suitably changed simply by changing an inner diameter of the upper end 11b of the piston guide 11 and an outer diameter of (the tubular portion 13d of) the slip-off preventing member 13. Moreover, the connecting flow path area S₂ for ambient air is defined by the L-shaped grooves 14g of the jet ring 14 illustrated in FIG. 4, and accordingly, the connecting flow path area S₂ may be suitably changed simply by changing the width and depth of the L-shaped grooves 14g.

Next, another embodiment of the present disclosure is described. This other embodiment is also directed to the foamer dispenser with the structure illustrated in FIGS. 1 to 4 in which the same-diameter circumferential wall portion 14a₂ has the smallest inner diameter in the through path formed inside the jet ring 14. That is to say, the smallest flow path area S₃ of the mixture flow path R_{M} is located on an immediately upstream side of one of the mesh filters 15a. The smallest flow path area S₃ of the mixture flow path R_{M} and a flow path area S₄ of the mesh filter 15a are preferably set to satisfy the aforementioned condition (3). Thus, in the foamer dispenser with the structure illustrated in FIGS. 1 to 4 according to the other embodiment of the present disclosure, the smallest flow path area S₃ of the mixture flow path R_{M} is located on an immediately upstream side of one of the mesh filters 15a, and the smallest flow path area S₃ and the flow path area S₄ of the mesh filter 15a are preferably set to satisfy the same condition as the condition (3).

In this other embodiment also, in addition to the condition (3), the aforementioned conditions (4) to (7) are preferably satisfied. Furthermore, in addition to the condition (3), the aforementioned conditions (1) and (2) may also be satisfied.

The following describes test results of Examples using a foamer dispenser with the structure illustrated in FIGS. 1 to 4 and Comparative Examples. The tests were conducted by using a body soap (skin cleanser) with ingredients of Table 1 shown below as the content medium of Examples and Comparative Examples.

TABLE 1

| Ingredients | Mass % |
|---|---|
| Sodium laurylaminopropionate | 3 |
| Lauramidopropyl betaine | 20 |
| Sodium N-cocoyl methyl taurate | 2 |
| Polyoxyethylene (2) disodium alkyl (12-14) sulfosuccinate | 10 |
| Sorbitol | 3 |
| Glycerin | 3 |
| Proplylene glycol | 20 |
| Sodium benzoate | 0.9 |
| Citrate | 0.7 |
| Honey | 0.1 |
| Sodium DL-pyrrolidone carboxylate solution | 0.1 |
| Dye | 0.01 |
| Purified water | Reminder |

### EXAMPLE 1

S₁/S₂₍ₐₗₗ₎=3.8

(S₁:S₂₍ₐₗₗ₎=3.8:1)

Connecting flow path area S₁ for the liquid=27.3 mm²

Connecting flow path area S₂ for ambient air=7.2 mm²

Note that the connecting flow path area S₂ herein refers to a total sum area S₂ of 12 connecting flow paths for ambient air.

### EXAMPLE 2

S₁/S₂₍ₐₗₗ₎₌2.8

(S₁:S₂₍ₐₗₗ₎=2.8:1)

Connecting flow path area S₁ for the liquid=20.16 mm²

Connecting flow path area S₂ for ambient air=7.2 mm²

Note that the connecting flow path area S₂ herein refers to a total sum area S₂ of 12 connecting flow paths for ambient air.

### EXAMPLE 3

S₄/S₃=4

(S₃:S₄=1:4)

Smallest flow path area S₃ of mixture flow path R_{M}=24.63 mm²

Flow path area S₄ of mesh filter=98.52 mm²

### EXAMPLE 4

S₄/S₃=4.2

(S₃:S₄=1:4.2)

Smallest flow path area S₃ of mixture flow path R_{M}=23.76 mm²

Flow path area S₄ of mesh filter=98.52 mm²

### EXAMPLE 5

S₄/S₃=6.2

(S₃:S₄=1:6.2)

Smallest flow path area S₃ of mixture flow path R_{M}=15.89 mm²

Flow path area S₄ of mesh filter=98.52 mm²

### EXAMPLE 6

S₄/S₃=10

(S₃:S₄=1:10)

Smallest flow path area S₃ of mixture flow path R_{M}=9.85 mm²

Flow path area S₄ of mesh filter=98.52 mm²

### EXAMPLE 7

S₄/S₃=10.3

(S₃:S₄=1:10.3)

Smallest flow path area S₃ of mixture flow path R_{M}=9.57 mm²

Flow path area S₄ of mesh filter=98.52 mm²

In the following, test results of the aforementioned Examples 1 to 7 according to the present disclosure are shown in Table 2. In Table 2, “good” indicates that the foam quality is good, and “excellent” indicates that the foam quality is better than good.

TABLE 2

| | Foam quality |
|---|---|
| Example 1 | Excellent |
| Example 2 | Good |
| Example 3 | Excellent |
| Example 4 | Good |
| Example 5 | Good |
| Example 6 | Good |
| Example 7 | Good |

It can be clearly seen from Examples 1 and 2 in Table 2 shown above that the foam quality of the ejected foam may be improved by setting the connecting flow path area S₁ for the liquid and the connecting flow path area S₂ for ambient air to satisfy the aforementioned condition (1). Especially, as can be clearly seen from Example 1, the foam quality is better when the aforementioned condition (2) is satisfied.

It can also be clearly seen from Examples 3 to 7 in Table 2 shown above that the foam quality of the ejected foam may be improved by setting the smallest flow path area S₃ of the mixture flow path R_{M} and the flow path area S₄ of the mesh filter to satisfy the aforementioned conditions (3) to (6). Especially, as can be clearly seen from Example 3, the foam quality is better when the condition (6) is satisfied. In cases of Examples 3 to 7, in which the smallest flow path area S₃ of the mixture flow path R_{M} and the flow path area S₄ of the mesh filter are set to satisfy the conditions (3) to (6), even when a large volume is ejected from the head, the head may be pushed down with feeling of lightness, as opposed to heaviness.

In eases in which Example 1 and Example 3 were combined, the foam quality was also better.

Furthermore, regarding Examples 1 to 7, when the interval L₁ between the smallest flow path area S₃ and the flow path area S₄ of the mesh filter was set to be 3.8 mm and when the interval L₂ between the mesh filters was set to be 15 mm and

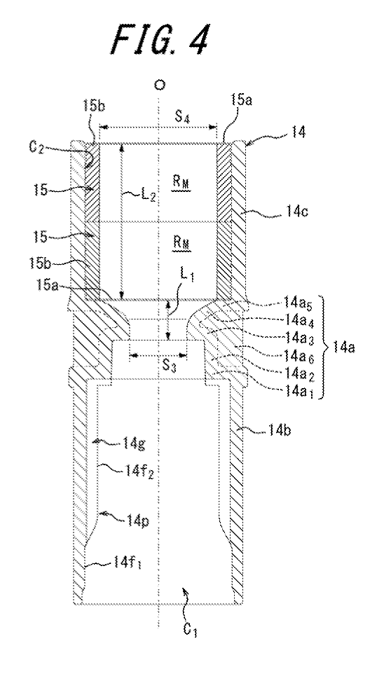

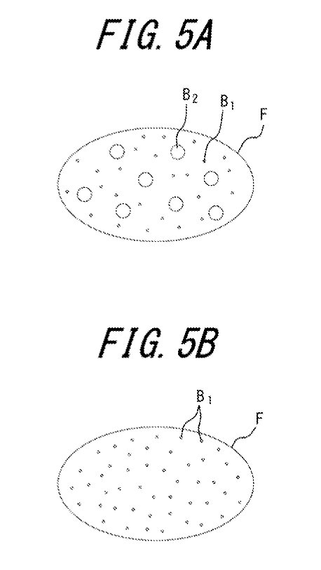

when the dimension settings of L₁:L₂=3.9 were combined with Example 1 or Example 3, the foam quality was even more than better. Moreover, when the above dimension settings were combined with Example 1 and Example 3, the foam quality was best. The foam quality obtained in this case is schematically illustrated in FIG. 5B. As illustrated in FIG. 5B, according to the present disclosure, the small air bubbles B₁ are evenly dispersed in the single piece of foam F compared with conventional example illustrated in FIG. 5A.

Additionally, although Examples use the jet ring of a type that may form the liquid flow path R_{L} and the air flow path Rₐᵢᵣ at the time of assembly, the present disclosure may also be adopted in a foamer dispenser using the jet ring of a conventional type that may form only the liquid flow path R_{L}.

### INDUSTRIAL APPLICABILITY

The present disclosure is applicable to a foamer dispenser that mixes a liquid content medium and ambient air and ejects the mixture in the form of foam and to a container with the foamer dispenser. The content medium may be anything, such as a face cleanser and a hair liquid, that may be mixed with ambient air and ejected in the form of foam.

### REFERENCE SIGNS LIST

1 Foamer Dispenser

2 pump cover

3 pump cylinder

3a large-diameter portion

3b small-diameter portion

6 small-diameter piston

7 elastic member

8 large-diameter piston

9 piston guide

11 ball member

12 slip-off preventing member

13d tubular portion

14 jet ring

14a separation wall

14a₁ first reduced circumferential wall portion

14a₂ same-diameter circumferential wall portion

14a₃ second reduced circumferential wall portion

14a₄ large-diameter circumferential wall portion

14a₅ third reduced circumferential wall portion

14a₆ reinforcing plate

14g L-shaped groove

15 mesh ring

15a mesh filter

20 container body

21 mouth

A₁ opening port of liquid flow path

A₂ opening port of ambient air flow path

C₁ lower-end side concave portion of jet ring

C₂ upper-end side concave portion of jet ring

R_{L} liquid flow path

Rₐᵢᵣ ambient air flow path

R_{M} mixture flow channel

S₁ connecting flow path area between liquid flow path and mixture flow path

S₂ connecting flow path area between ambient air flow path and mixture flow path

S₃ smallest flow path area of mixture flow path

S₄ flow path area of mesh filter

1. A foamer dispenser, comprising:
a pump cover that is fitted to a container body;
a pump cylinder that includes a large-diameter portion fixed to the pump cover and a small-diameter portion;
a small-diameter piston that is received in the small-diameter portion of the pump cylinder and that is configured to suck and pump a liquid in the container body;
a large-diameter piston that is received in the large-diameter portion of the pump cylinder and that is configured to suck and pump ambient air;
a head that causes pumping movement of the small-diameter piston and the large-diameter piston and that ejects a mixture of the liquid and the ambient air by a user pushing and releasing the head repeatedly;
a liquid flow path of the liquid pumped from the small-diameter piston;
an ambient air flow path of the ambient air pumped from the large-diameter piston;
a mixture flow path of the mixture of the liquid pumped from the liquid flow path and the ambient air pumped from the ambient air flow path; and
a mesh filter that is disposed in the mixture flow path to allow the mixture to pass,
wherein a smallest flow path area S₃ of the mixture flow path is located on an immediately upstream side of the mesh filter, and the smallest flow path area S₃ and a flow path area S4 of the mesh filter have the following relation:
4≤S₄/S₃≤10.3,
wherein a check valve is located in the liquid flow path on a downstream side of the small-diameter piston, and a slip-off preventing member that restricts movement of a valving element of the check valve provides an opening configured to communicate the liquid flow path and the mixture flow path with each other.

2. The foamer dispenser of claim 1, wherein
the smallest flow path area S₃ and the flow path area S₄ of the mesh filter have the following relation:
4≤S₄/S₃≤10.1

3. The foamer dispenser of claim 1, wherein
the smallest flow path area S₃ and the flow path area S₄ of the mesh filter have the following relation:
4≤S₄/S₃≤6.2

4. The foamer dispenser of claim 1, wherein
the smallest flow path area S₃ and the flow path area S₄ of the mesh filter have the following relation:
S₄/S₃=4

5. The foamer dispenser of claim 1, wherein
the mesh filter is arranged in 2 locations in the mixture flow path, and an interval L₁ between the smallest flow path area S₃ and the flow path area S₄ of the mesh filter and an interval L₂ between the mesh filters have the following relation:
L₂/L₁=3.9

6. The foamer dispenser of claim 1, further comprising:
a piston guide, inside of which the liquid flow path of the liquid pumped from the small-diameter piston is formed, and which extends throughout the large-diameter piston in a mariner such that relative movement is permitted; and
a jet ring, which includes a lower-end side concave portion in which an upper end side of the piston guide is received, an upper-end side concave portion in which the mesh filter is received, and a through path provided in a separation wall separating the lower-end side concave portion from the upper-end side concave portion,
wherein an upper end side of the jet ring is connected to the head.

7. The foamer dispenser of claim 5, further comprising
a piston guide, inside of which the liquid flow path of the liquid pumped from the small-diameter piston is formed, and which extends throughout the large-diameter piston in a manner such that relative movement is permitted; and
a jet ring, which includes a lower-end side concave portion in which an upper end side of the piston guide is received, an upper-end side concave portion in which the mesh filter is received, and a through path provided in a separation wall separating the lower-end side concave portion from the upper-end side concave portion,
wherein an upper end side of the jet ring is connected to the head.

8. A container with a foamer dispenser, comprising:
the foamer dispenser of claim 1; and
a container body to which the foamer dispenser is fitted.

9. A container with a foamer dispenser, comprising:
the foamer dispenser of claim 5; and
a container body to which the foamer dispenser is fitted.

10. A container with a foamer dispenser, comprising:
the foamer dispenser of claim 6; and
a container body to which the foamer dispenser is fitted.

11. A container with a foamer dispenser, comprising:
the foamer dispenser of claim 7; and
a container body to which the foamer dispenser is fitted.
